(19) United States
(12) Patent Application Publication
(10) Pub. No.: US 2015/0250668 A1
(43) Pub. Date: Sep. 10, 2015

(54) WHEELCHAIR EQUIPPED WITH A CRANE HAVING AN EXTENSIBLE MODULE WITH X-SHAPED CROSSES

(71) Applicant: 8582106 CANADA LTD, Montreal (CA)

(72) Inventor: Michel De La Place, Magog (CA)

(21) Appl. No.: 14/428,846

(22) PCT Filed: Sep. 17, 2013
(86) PCT No.: PCT/CA2013/000776

§ 371 Date: Mar. 17, 2015

(30) Foreign Application Priority Data
Sep. 21, 2012 (CA) 2790762
Jan. 10, 2013 (CA) 2801480

(51) Int. Cl. A61G 5/10; A61G 7/10; E04H 12/18; B66C 23/16; B66C 23/72; B62D 7/15

(52) U.S. Cl. CPC A61G 5/10; B66C 23/72; B62D 7/15; E04H 12/18; B66C 23/16; A61G 7/1019; A61G 2005/1051

(57) ABSTRACT

Wheelchairs equipped with a crane, cranes, scaffolding and handling equipment comprising electrically activated extensible structures of articulated trellis, providing large extension relative to retracted length and handling cantilever loads. Crane stabilizers combining the additional functions of wheel axle, crane leveller, vehicle suspension and carrier of counterweight. Electric wheels acting as crane turntable. Electric wheels independently steered with angular actuators and integrated with an assembly of spring suspension, of shock absorber that can be locked to insure crane steadfastness and of linear actuator for levelling. Wheelchair seats with pro file varied by the combination of an electrical linear actuator adjusting the angle of the backrest and the motorized extension of the main frame of the vehicle. Seat covers framed with pressurized tubes made of composite films acting as structural elements, said seat covers also used as mattress and equipped with a removable chamber pot. Fixtures for integration of modules.

### TECHNICAL FIELD

Wheelchairs equipped with a crane handling their users, cranes, material handling equipment, vehicles with four modes of steering and suspensions integrated with linear actuator.

### BACKGROUND OF ART

The rapid aging of the population will demand equipment increasing the autonomy of the aged and consequently this equipment will reduce the expense in hiring caregivers or, at least, facilitate the work of caregivers. Special residences for the aged will not be available in sufficient quantity and the emphasis will be placed on keeping people at home and provide home care. Apparatus hanging from the ceilings and travelling on rails are the choice for new hospitals and buildings destined for special residences but their installation in private homes is expensive and defacing and still needs transfers from- and to-wheelchairs between stations.

There is a good number of pieces of equipment in existence to handle the handicapped but their respective capability covers narrow fields. There is a need for a mobile unit performing various tasks and eliminating transfers. Such a unit is a special wheelchair equipped with a crane offering the capability for a handicapped person to perform themselves the following actions: move on a bed, roll on a bed, transfer to the seat of the wheelchair, to an armchair, to a toilet, to a bathtub with zero ground clearance, into an automobile and remote controlled loading and unloading the unit at the back of an automobile. Also to be picked-up with assistance from the ground after a fall.

The present time coincides with the availability of electric wheels, electric actuators offering force and speed, step motors, servo drives, integrated controls, solid state components, radio remote controls, vocal commands and new types of controls responding to pressure or movement or even, in the future, eventually controls commanded by a brain scanner, nerve connections and muscle contraction.

Over the past five years, the inventor conceived a dozen designs that ended in complicated and expensive solutions but finally arrived at a practical solution by conceiving novel electrically powered two and three axis trellis type extensible structures and making components perform more than one task, thus reducing the number of components.

As examples, with regard to components performing more than one task, the wheels of the vehicle also act as crane turntable and the stabilizers replace the wheel axles, participate to the suspension and the levelling of the crane.

Being an engineer with long experience in mining and construction equipment he saw interesting applications for the modules that are part of his invention in the fields of cranes, scaffoldings, material handling equipment and vehicles to reduce their cost, weight and encumbrance and suited to use electrical systems instead of hydraulic systems. He also emphasized the use of modules, giving the possibility of gradually adding capabilities to the acquired piece of equipment, starting with moderately priced basic units and giving the advantage of interchanging modules for repair without immobilisation of the unit.

### DISCLOSURE OF INVENTION

There are three versions of the combination of a wheelchair equipped with a crane.

The crane comprises an extensible vertical mast mounted on a compartment containing batteries and a horizontal extensible boom which can be oriented and capable of operating in opposite directions depending on the possibility of extending extensible stabilizers due to obstacles. When there is no room to extend the extensible stabilizers, the extensible stabilizers are either carrying counterweights at their far extremity or are anchored to the ground. The fact that the stabilizers are extensible results in using counterweights that are considerably less heavy that those usually used on existing cranes.

The crane is similar in the three versions. The vehicle and the extensible stabilizer(s) attached to the vehicle are the elements that distinguish the versions.

The main frame of the vehicle is narrow in order to house one or two retracted stabilizers under the seat which forms a cantilever over the space occupied by the retracted stabilizers.

The main frame of the vehicle has only two wheels and the other two wheels are situated under the far ends of two extensible stabilizers.

In the first version all the wheels are swivel wheels. In the second version the two wheels situated under the frame are electric wheels that can be steered over a full 360 degrees by an electric angular actuator and are equipped with a combination of electric linear actuator and spring with shock absorber which can be blocked. As such, these wheels participate to the suspension of the vehicle when travelling and keep the crane up-straight and steadfast when working on uneven terrain.

Also, in this second version, each stabilizer is articulated at its junction with the frame. This articulation is actuated by a combination of electric linear actuator and spring with shock absorber which can be blocked. As such, the stabilizers participate to the suspension of the vehicle when travelling and keep the crane up-straight and steadfast when working on uneven terrain.

In the third versions the vehicle proper has four electric wheels and there is only one extensible stabilizer. This stabilizer is equipped with two swivel wheels at its far end. The swivel wheels of the stabilizer are off the ground when travelling and on the ground when the crane is active. The vehicle is then really a road and all terrain vehicle which has a variable ground clearance to be able to lower the vehicle to introduce the extensible stabilizer under objects having small ground clearance. The wheels of the vehicle and the actuation of the stabilizer have the same features as in the second version.

The two electric wheels of the second version and the four electric wheels of the third version are programmed to act as crane turntable. They are also programmed to have the rear wheel(s) follow approximately the track(s) of the front wheel(s) and also to steer all the wheels by ninety degrees for a lateral movement of the vehicle offering easy parking.

The extensible mast, extensible boom and extensible stabilizers are articulated two and three axis assemblies of trellis linked with corner pieces or crossing webs giving them large extensibility and resistance to bending and twisting in all directions.

The extensible mast comprises rows of X-shaped articulated crosses placed in the side planes of a prism and the rows have their sides interlinked with corner pieces bearing articulations.

The boom and stabilizer(s) comprises two rows of X-shaped articulated crosses placed facing one another in parallel planes and interconnected with crossing webs.

These two types of two and three axis extensible trellis type structures will find applications in cranes, scaffolding and material handling thanks to their combination of extensibility, resistance to bending and twisting, to being driven by electricity and to the small number and size of actuators.

These two and three axis trellis type structures are extended and retracted by linear and, or, angular actuators in combination with springs that provide additional force mainly during the first stretch of extension from the retracted stage. Thanks to these springs, the needed actuators are of lower capacity but have to work during retraction as much as during extension. If the springs are designed to be able to power the extension on their own, a winch and cable or winches and cables perform the retraction.

When very strong resistance to bending in one particular direction is required, these novel two and three axis articulated trellis can be affixed alongside, sharing elements of the rows of X-shaped crosses through which they are linked.

This affixing alongside can also be used to make long extensible crane booms, long extensible stabilizers, extensible walls, roofs and temporary bridges.

### BRIEF DESCRIPTION OF THE DRAWINGS

FIG. 1 is a schematic view of an extensible structure consisting of congruent rows of articulated X-shaped crosses connected end to end. Each row is situated in a separate side face of a prism. The sides of the rows of adjacent side faces are interconnected by corner pieces forming articulations. Each of the two ends of the extensible structure is held and guided in enveloping rail guides, where movement of the arms of the articulated X-shaped crosses is propelled by motorized means to extend or retract the extensible structure. Spreading the arms causes retraction and bringing them closer together causes extension.

FIG. 2 is a schematic representation in plan view, front elevation and side elevation of an interconnecting corner piece for the extensible structure of FIG. 1. An optional spring assists in the powered extension of the structure of FIG. 1.

At both ends of each row there are two arms and FIG. 3 is a schematic representation in plan view and side elevation of an interconnecting corner piece linking the arms, in pairs, of adjacent rows. This corner piece has an additional post to be held and guided in the enveloping rail guides of FIG. 1.

FIG. 4 is a schematic representation in plan view and side elevation of the articulation at the center of each X-shaped cross of the extensible structure of FIG. 1.

FIG. 5 is an illustration of a type of actuation of the extension and the retraction of the extensible structure of FIG. 1 provided at one of its two ends by a cross that is rotated by an angular actuator, which is not shown on the illustration, and connecting rods connected to the arms of the extensible structure of FIG. 1. Springs are assisting the angular actuator.

FIG. 6 is a schematic representation of an extensible structure consistsing of two congruent articulated rows of X-shaped crosses placed in parallel planes and facing one another orthogonally. Each pair of facing crosses are linked by two crossing webs specially conceived not to interfere with one another when the extensible structure is retracted or extended.

One or two ends of the extensible structure are held and guided in enveloping rail guides, where movement of the arms of the articulated X-shaped crosses is propelled by motorized means to extend or retract the extensible structure. Spreading the arms causes retraction and bringing them closer together causes extension.

The distances between the parallel planes of an X-shaped cross and the opposite X-shaped cross can vary in steps, decreasing gradually from one end to the other end of the extensible structure if the moment applied in a plane perpendicular, or near perpendicular, to the planes of the X-shaped crosses decreases gradually as is the case when the said structure is in cantilever.

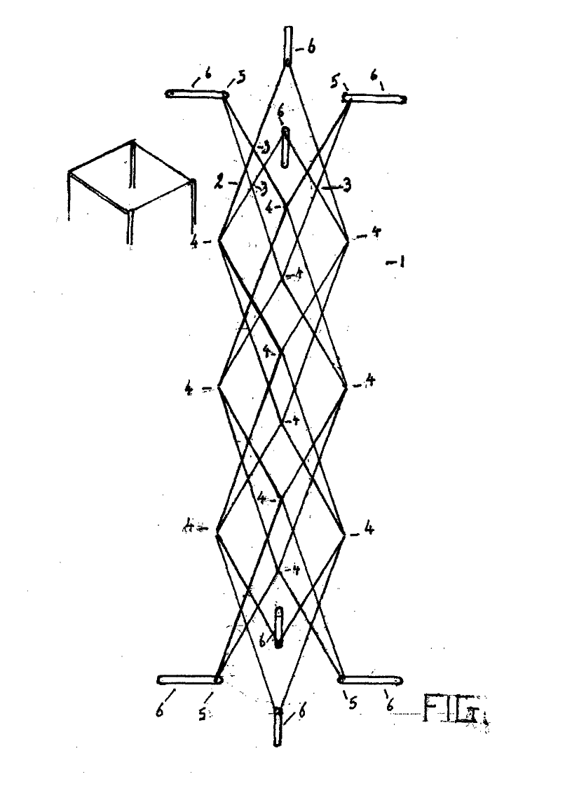

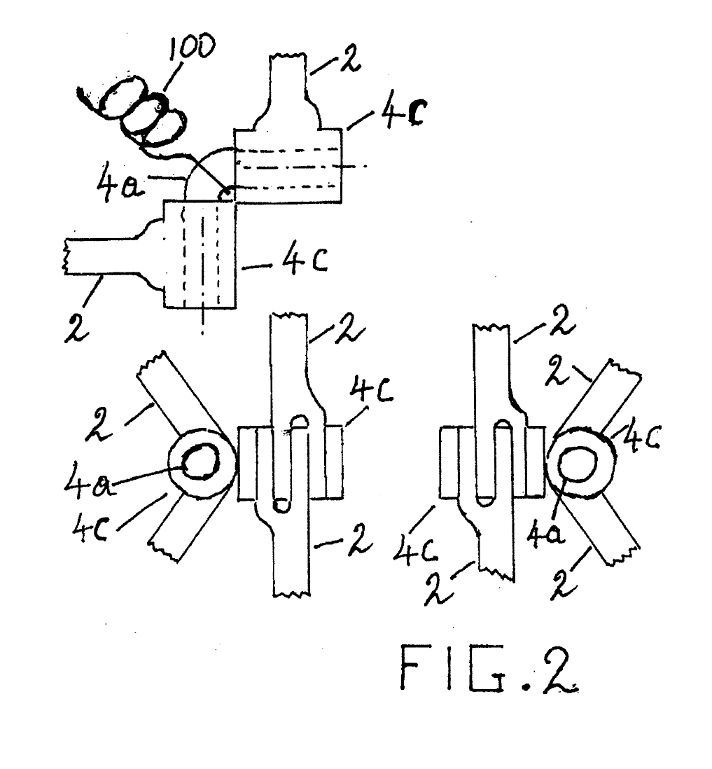

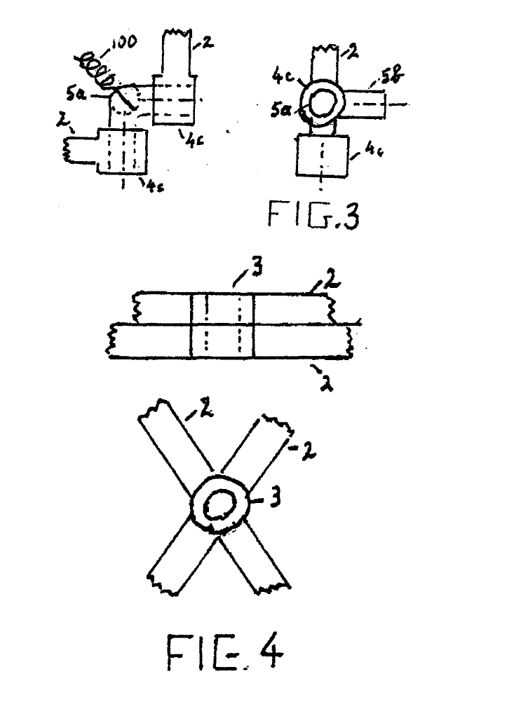

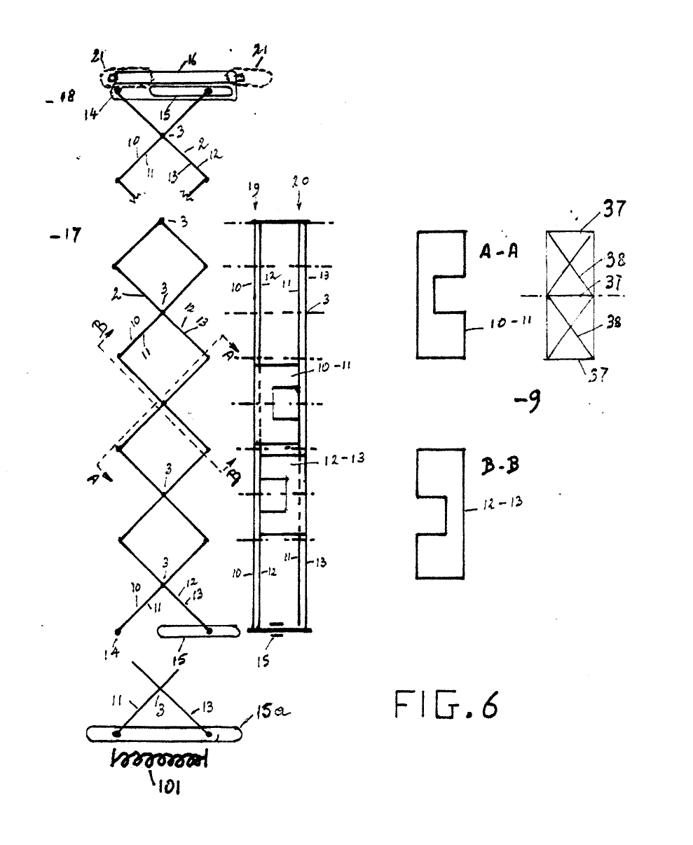

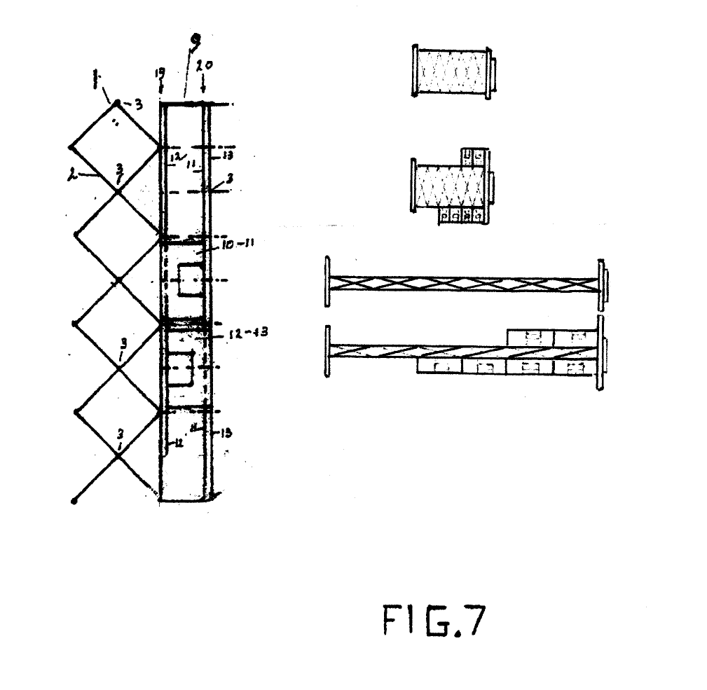

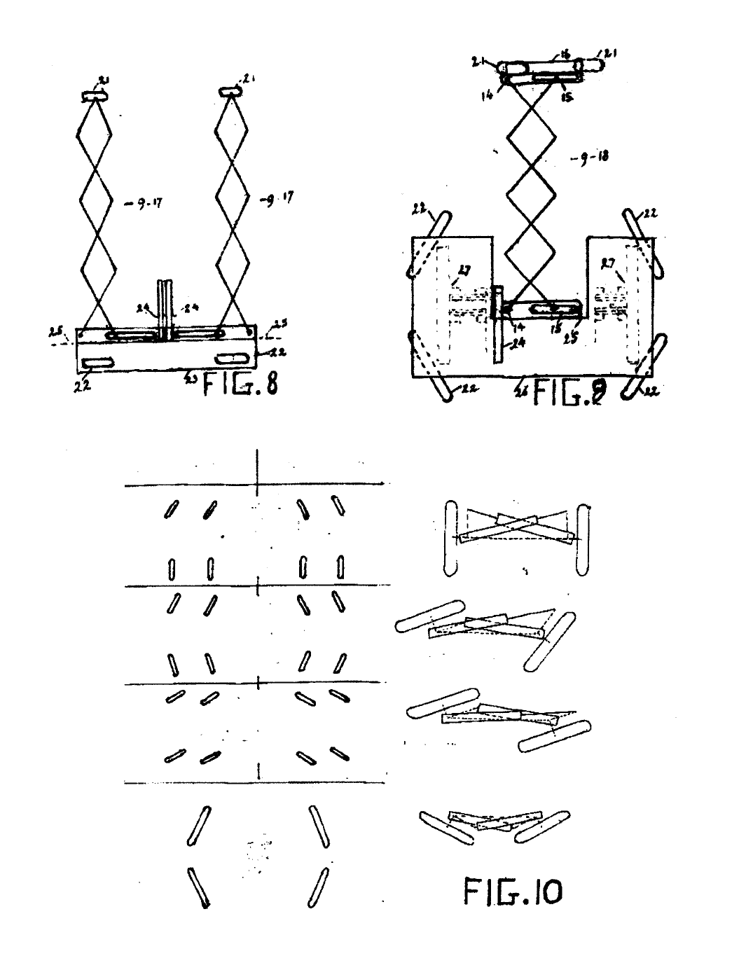

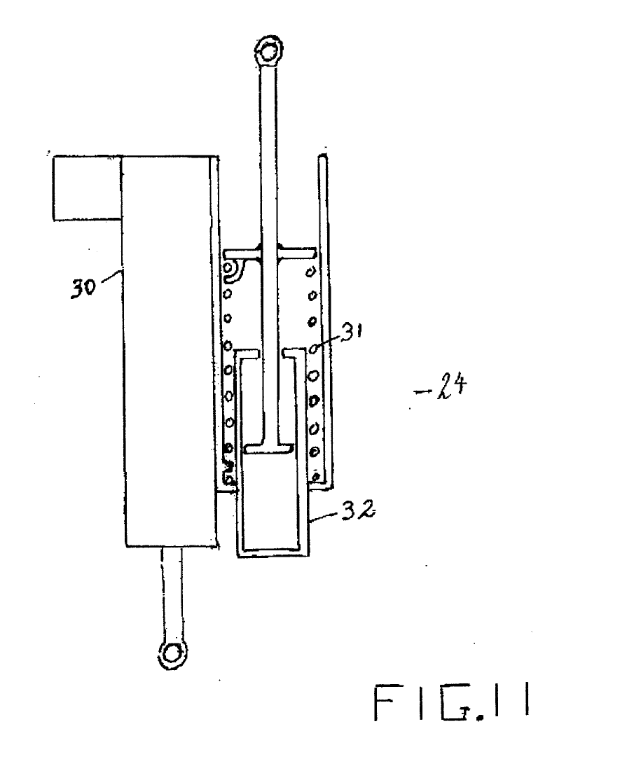

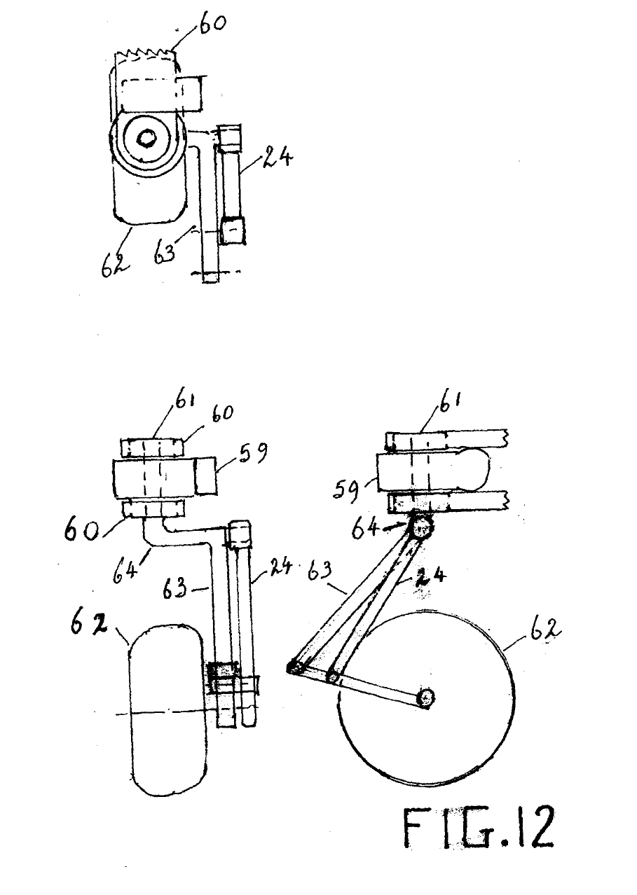

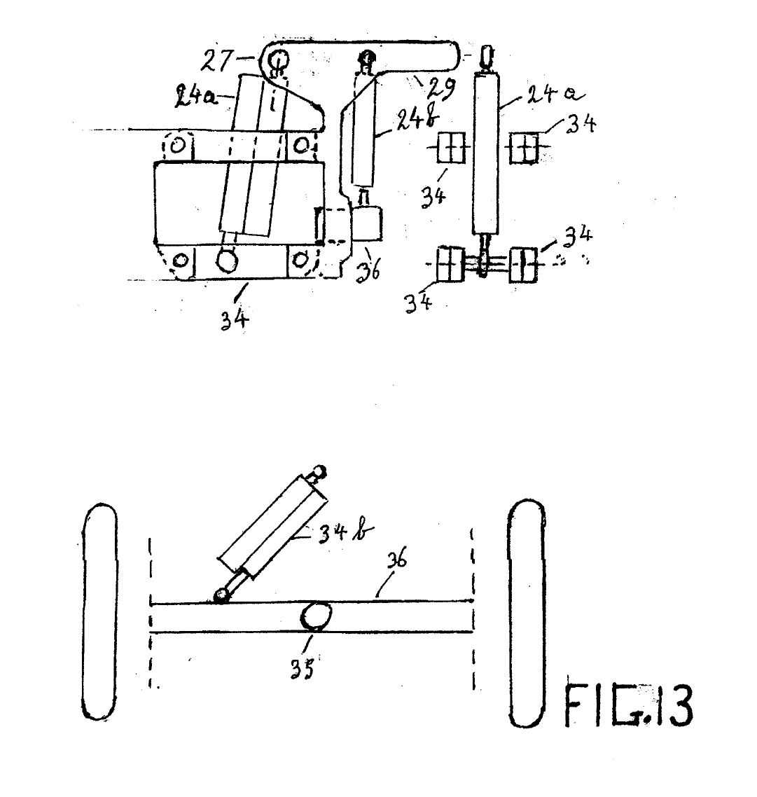

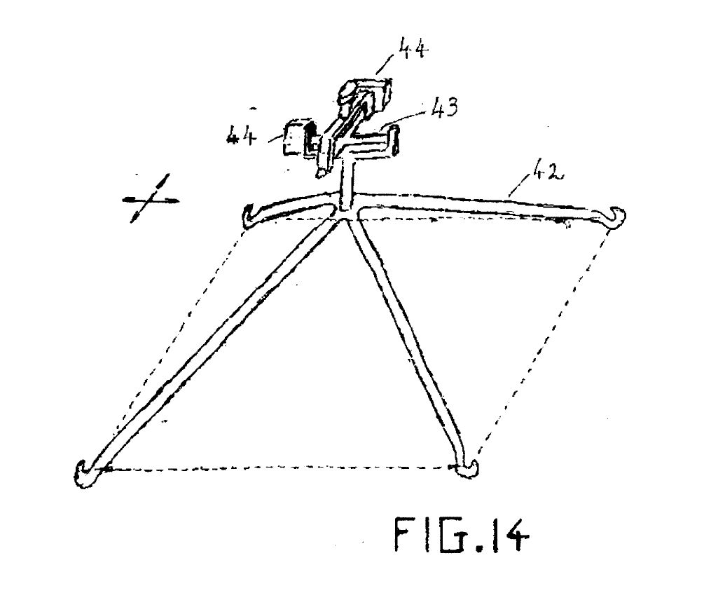

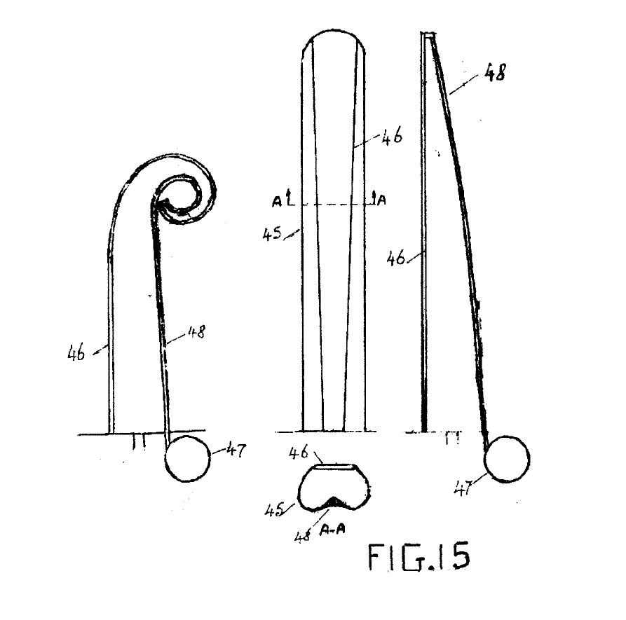

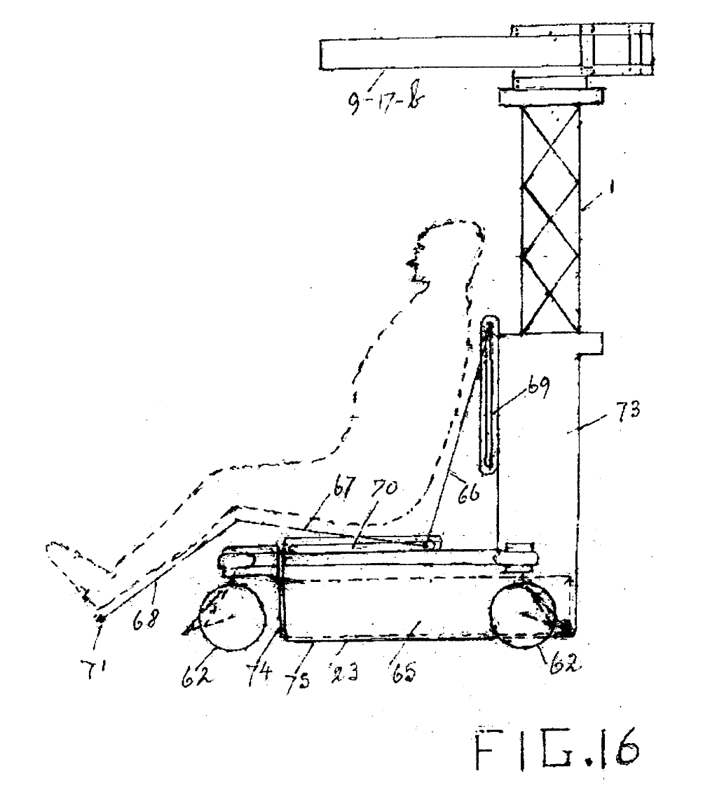

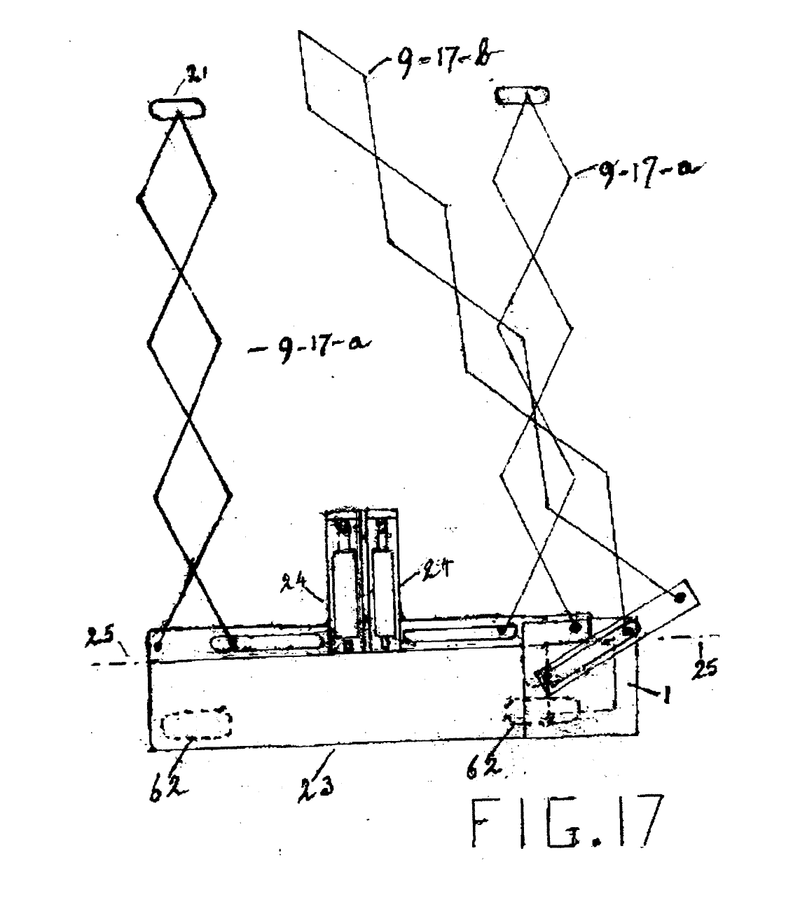

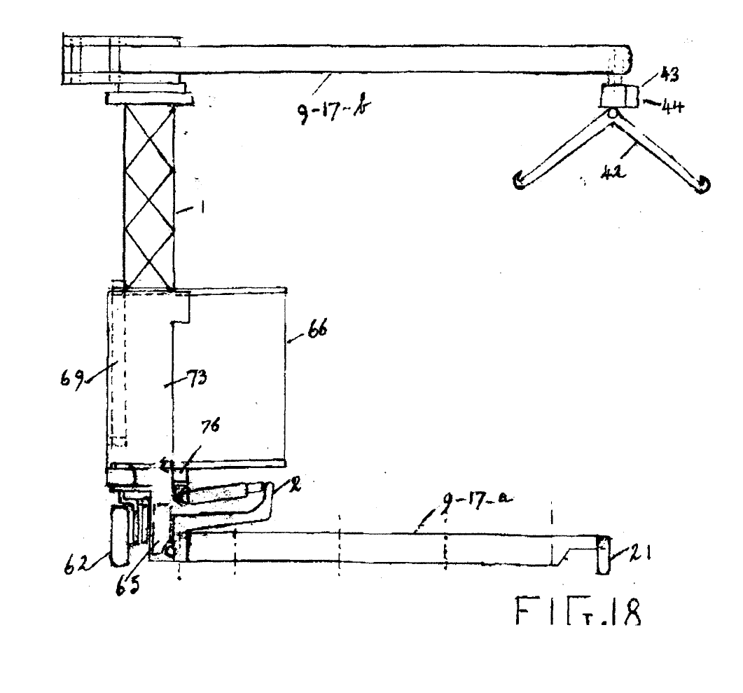

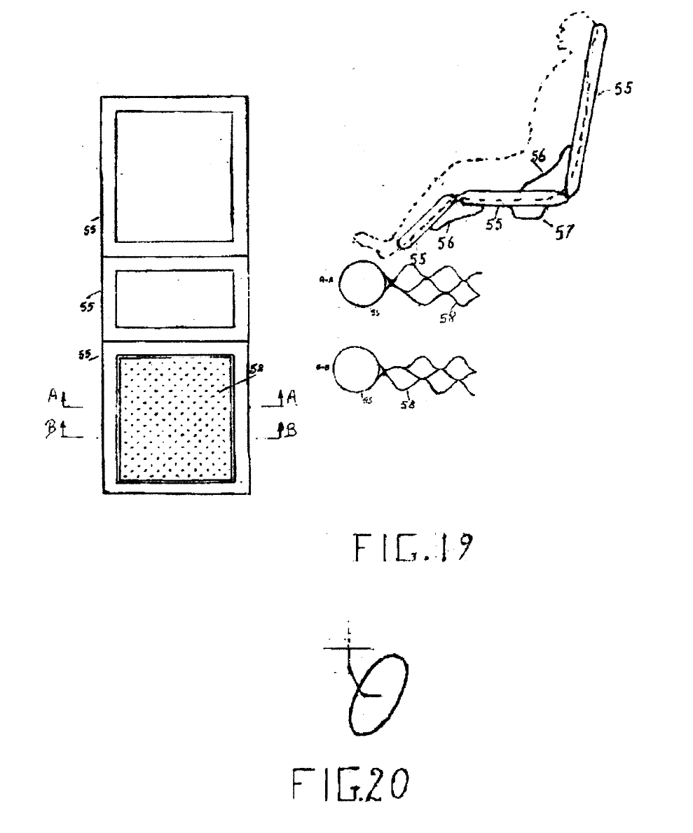

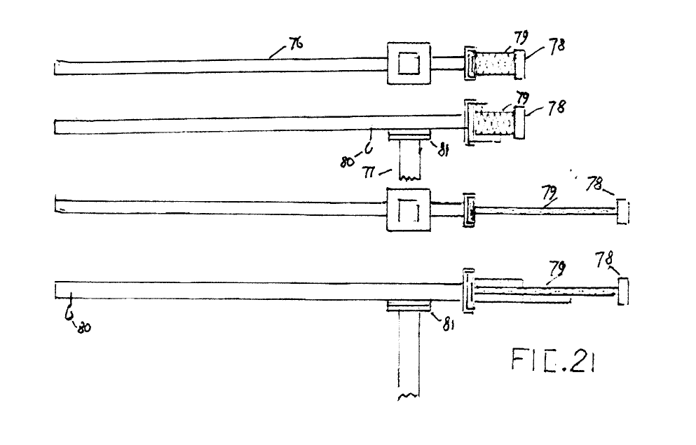

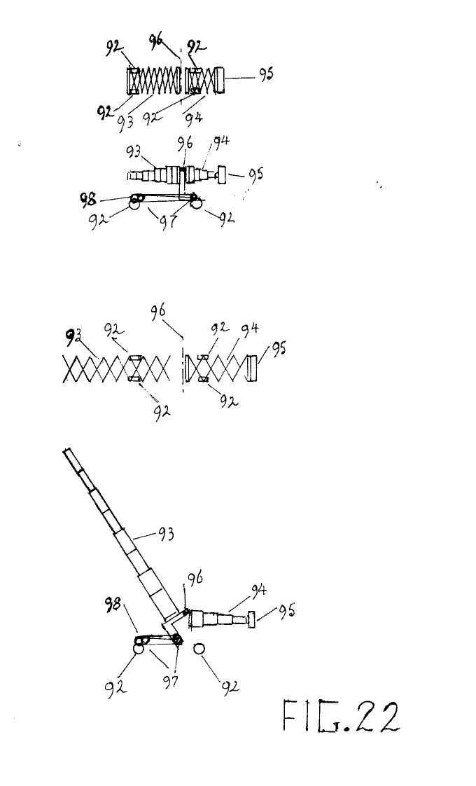

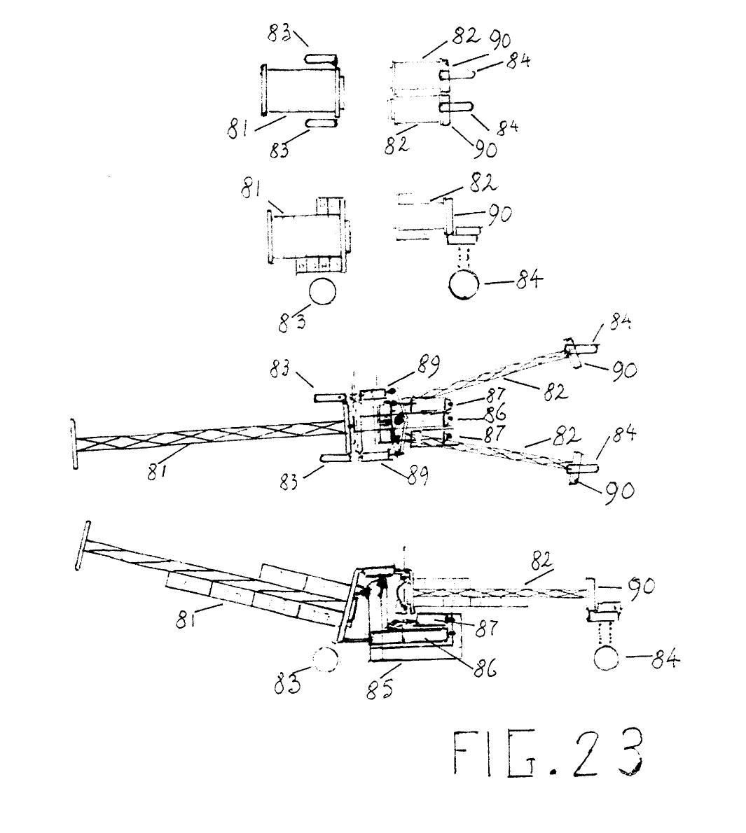

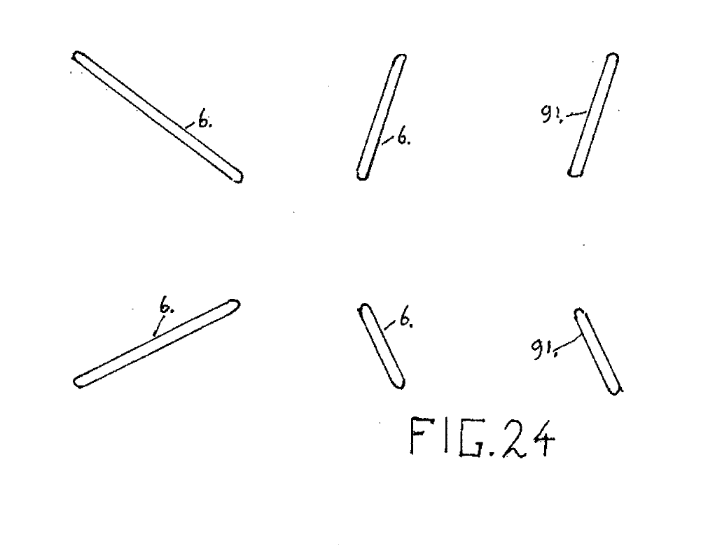

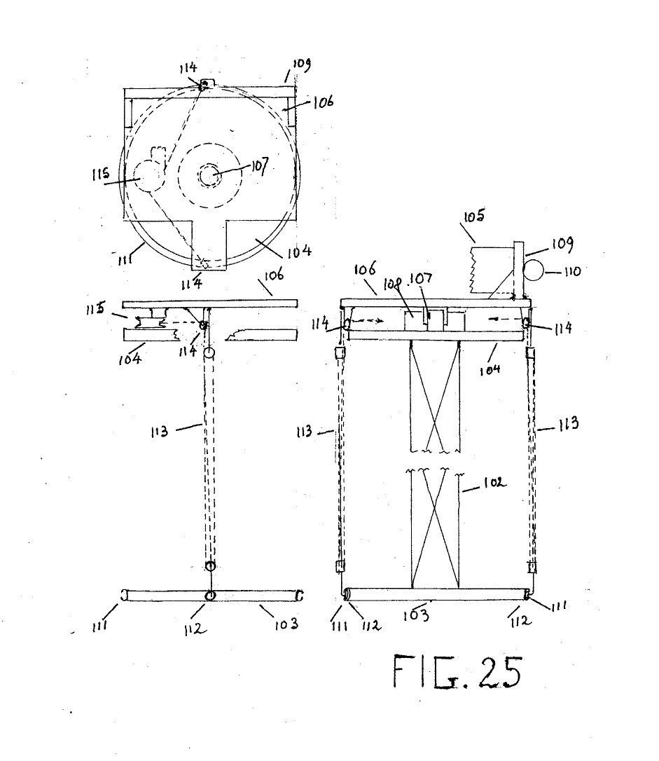

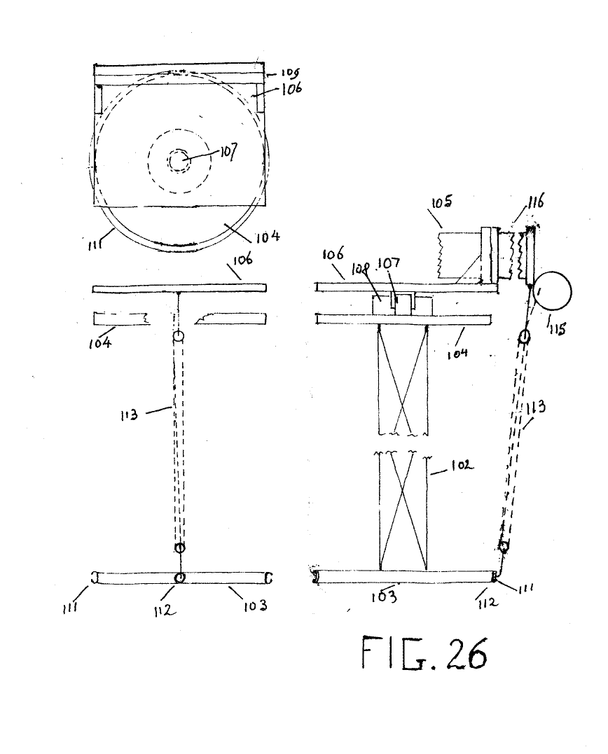

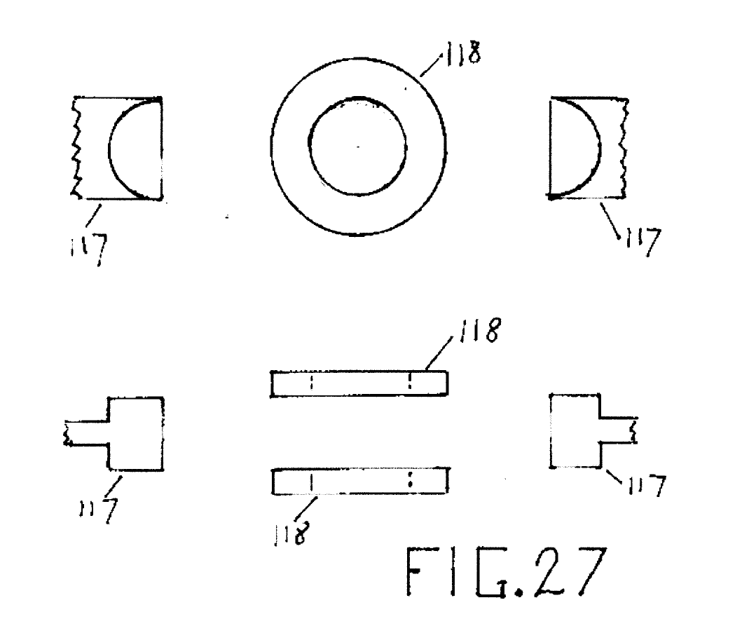

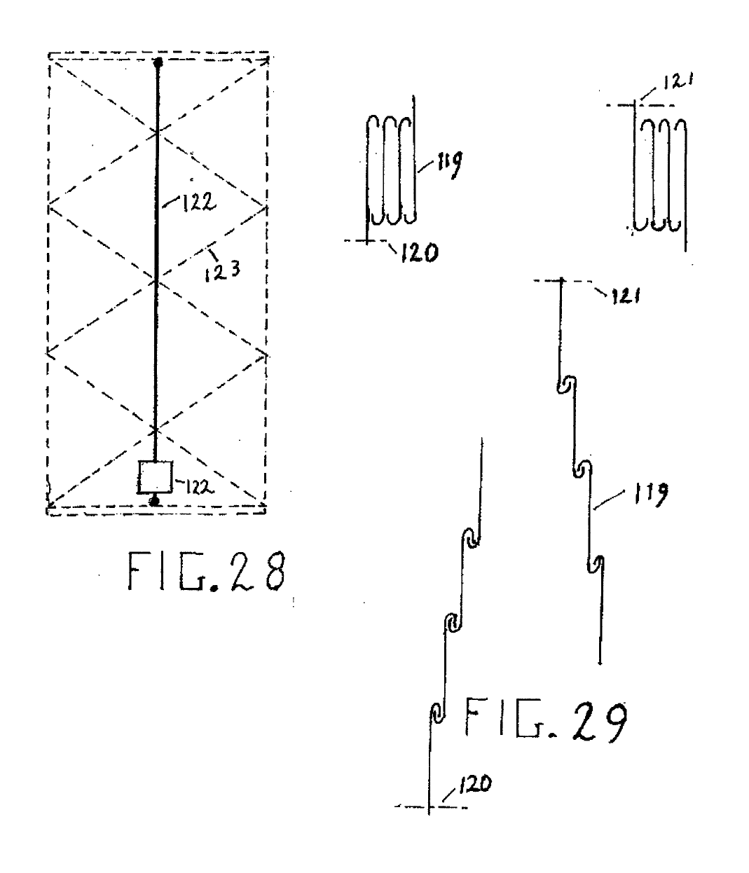

FIG. 7 includes schematic representations of affixing side-by-side structures represented on FIGS. 1 and 6. This affixing achieves greater resistance to bending in one particular direction. Adjacent structures share a common row of X-shaped crosses.

FIG. 8 is an illustration of positions of wheels of a mobile crane using two stabilizers which are extensible structures represented schematically on FIG. 6 There are two wheels under the main frame of the vehicle and a wheel under each far end of the extensible stabilizers. In this way the two stabilizers participate to the function of the crane when the crane is in operation and to the function of the vehicle when travelling.

FIG. 9 is an illustration of positions of wheels of a mobile crane having four wheels under the main frame of the vehicle and using only one stabilizer with two wheels under its extremity.

FIG. 10 is an illustration of four modes of steering. From top to bottom: standard, rotary where the rear wheels follow approximately the tracks of the front wheels, lateral for easy parking and turntable to provide the effect of a crane turn table.

FIG. 11 is a schematic representation of the combination of linear actuator, coil spring and shock absorber, the last equipped with a locking device. This combination is to be used in a vehicle to combine the suspension, the variation of ground clearance, the pitching, rolling and steadfastness at rest.

FIG. 12 is an illustration of an integration of electric wheel with angular actuator for steering and spring and shock absorber with locking device for suspension and linear actuator to vary the ground clearance.

FIG. 13 is a schematic representation of the suspension mechanisms held by the sub-frames of FIG. 9.

FIG. 14 is a schematic representation of a hanger to be installed at the far end of a boom of a crane including a connection with universal joint and two clutches to tilt the hanger in two orthogonal directions.

FIG. 15 is a schematic representation of a tube made of a film of composite material, inflatable at high variable pressure, combined with a leaf spring, to be used as extensible boom or extensible stabilizer for a crane or wheelchair equipped with a crane or other types of handling equipment.

FIG. 16 is a schematic elevation side view of the wheelchair equipped with a crane.

FIG. 17 is a schematic plan view of the wheelchair equipped with a crane.

FIG. 18 is a schematic elevation rear view of the wheelchair equipped with a crane.

FIG. 19 shows a schematic side view and a schematic plan view of a seat cover that can be used as an inflatable mattress comprising three sections that can be individually tilted. Each section is bordered with tubes inflated at high pressure to provide rigid frames. The space between high pressure tubes is filled by three membranes that form two chambers inflated at a lower pressure. Optionally, the tilting is activated and held by artificial muscles. A removable chamber pot is attached under the mattress.

FIG. 20 is a schematic representation of an inclined swivel wheel. This configuration reduces the vertical space use by a wheel whilst being able to use wheels of greater diameter.

FIG. 21 is a schematic representation of an extensible trellis type structure mounted horizontally at the counterweight end of the boom of a tower crane with this structure carrying the counterweight at its end.

FIG. 22 is a schematic representation of a mobile crane with extensible trellis type structures corresponding to that of FIG. 6 used for the boom and for the extensible structure carrying a counterweight at its far end. The counterweight consists entirely or partially of batteries to store electricity. The four wheels under the vehicle are each an assembly of FIG. 12.

FIG. 23 is a schematic representation of a mobile crane with affixed (see FIG. 7) extensible trellis type structures used for the boom and for the two stabilizers carrying each a counterweight at its distal end. These stabilizers are oriented vertically and horizontally using actuators. The wheel under the far end of each stabilizer is one of the four wheels of the vehicle. The other two wheels are each an assembly of FIG. 12.

FIG. 24 is a schematic representation of the enveloping guide rails guiding and holding the arms at the ends of trellis type extensible structures when a structure of FIG. 1 is affixed to a structure of FIG. 6.

FIG. 25 is a schematic representation of a vertical extensible mast of the type represented on FIG. 1 supporting a horizontal boom of the type represented on FIG. 6. The latter can be swung in any direction using an angular actuator. In this example, springs power the lifting by the vertical mast on their own. Two tackles control the extension and perform the retraction. They are mounted in such a way that they rotate with the boom and increase the rigidity of the mast in the direction of the boom.

FIG. 26 is a variation of FIG. 25 where there is only one tackle and where top of the tackle is attached to the distal end of an additional horizontal extensible boom attached to the rear of the horizontal extensible boom and extending in the opposite direction.

FIG. 27 is a schematic representation of a coupling system to join modules such that all interchangeable modules carry identical fixtures forming a congruent pattern that are either all female or all male elements joined respectively by male and female couplings.

FIG. 28 is a schematic representation of a restraining mechanisms linking the two ends of an extensible structure, equipped with single action spring actuator(s), releasing at low speed but locking at fast speed, such as used for automobile seatbelts, to prevent uncontrolled expansion of said extensible structure in case of failure of a single action actuator comprising cable with winch.

FIG. 29 is a schematic representation of a thin springy solid sheet forming a ribbon coil having one end fastened to a distal arm extremity at one end of an extensible structure as represented on FIG. 1 and FIG. 6 and having the other end fastened to a distal arm extremity at the opposite end of said structure; the ribbon coil wrapping around the said structure and extending in the form of a spiral that stretches longitudinally and simultaneously shrinks its cross section in step with the longitudinal extension and simultaneous shrinkage of cross section of said structure.

### DESCRIPTION OF THE PREFERRED EMBODIMENTS INCLUDING BEST MODE OF CARRYING THE INVENTION, MODE OF CARRYING THE INVENTION AND INDUSTRIAL APPLICABILITY

Referring to the drawings in detail, FIG. 1 is a schematic view of an extensible structure 1 that offers long extensions relative to its collapsed length and is resistant to bending and twisting in all directions, capable of lifting and moving, of exerting force in the direction of its longitudinal axis, of carrying and moving loads at cantilever in any direction and of sustaining lateral loads in any direction. The extensible structure 1 consists of articulated rows of X-shaped crosses 2 (St Andrew's crosses) (commonly called scissors) connected end-to-end. Each individual row is situated in one of the side faces of a four-sided orthogonal regular prism. Each row is parallel to the intersections of the side faces of the prism. Each X-shaped cross 2 is articulated in its center 3. The row of each face of the prism is connected with articulations to the row of each adjacent face at points 4 and 5.

At the top and bottom ends 5 of the assembly of X-shaped crosses 2, the extremities are held and guided in enveloping rail guides 6 mounted in a tray perpendicular to the rows of shaped crosses. The gathering closer together of these extremities extends the extensible structure 1. In reverse their moving away from one another retracts the extensible structure 1. The enveloping rail guides are each aligned on a radius from a point common to the radii of enveloping rail guides of the four corner pieces. This common point is not necessarily in the center as illustrated on FIG. 1.

The cross-section of this structure decreases in the two orthogonal directions when the structure is extended. Each of these two orthogonal dimensions of this cross-section decreases by 64% when the angle made by the arms of the X-shaped crosses and the cross-section varies from 15 degrees to 70 degrees which is the best practical field. At 15 degrees, the effort deployed by such arms in the direction of their longitudinal axis to lift a load carried by the structure in the direction of its extension is approximately four time that of the load. Past 70 degrees, an increase of this angle has negligible effect on the extension. The ratio of extended length to retracted length is 3.5. The comparable ratio with the best three-sections telescoping masts, made of the best steel and using hydraulic rams, presently used on cranes, is 2.6. The trellis type approach reduces the weight and the price.

Should it be desirable to keep one corner of the extensible structure 1 in a fixed position, the enveloping rail guides would have to radiate from that corner.

FIG. 2 is a schematic view in three orthogonal projections of details of the connections at 4 on FIG. 1 that link two adjacent rows of X-shaped crosses of FIG. 1.

The extremities of the X-shaped crosses of adjacent rows of X-shaped crosses are connected at 4 to one another by a corner piece 4a. The two extremities of corner piece 4a have each an articulation 4c. Each articulation 4c connects two extremities of X-shaped crosses belonging to of one of the two adjacent rows. The articulations are perpendicular to their respective row of X-shaped crosses.

FIG. 3 is a schematic view in two orthogonal projections of details at connections 5 that joint four pairs of arms at the bottom end and four pairs of arms at the top end of the extensible structure 1. Item 5a is a corner piece with two articulations 4c that link the extremities of a pair of arms 5. The corner piece 5a is fitted with a short leg 5b whose extremity moves into one of four radial enveloping rail guides 6 of FIG. 1.

FIG. 4 is a schematic view in two orthogonal projections of the articulation at the center 3 of each X-shaped cross 2.

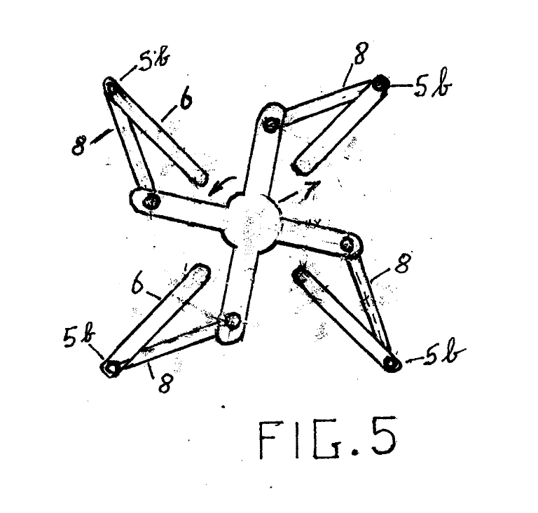

The variation of the extention of the extensible structure 1 can be powered in a number of fashions:
such as having an electric track linear type actuator, or a worm drive actuating a translation screw, that pulls sets of two diagonally opposed pairs of arm extremities 4 and 5 toward one another in order to extend the mast. Coil springs 100 stretched between said pairs can 3 assist the above actuators.
or using an angular actuator rotating a mechanism such as illustrated on FIG. 5. The angular actuator rotates the cross 7 which, through the connecting rods 8, commands the movement of the arms 5b in the enveloping rail guides 6 of FIG. 1. The center of this cross corresponds to the point common to the radii of enveloping rail guides of the corner pieces. When this point is off-center, the connecting rods 8 do not all have the same length. Their respective length is then proportional to the distance between to said point and the position of their respective arm extremity 5 when the extensible structure 1 is fully extended.
When spring 101 of FIG. 6 and springs 100 of FIGS. 2 and 3 are strong enough to completely extend the extensible structure 1 of FIG. 1, the retraction of said structure is done by a cable and winch, the extremity of the cable being attached to one end tray containing the enveloping guide rails and the winch attached to the opposite tray.

The said springs are fully stretched when the extensible structure 1 of FIG. 1 is retracted and partially or fully relieved when the said structure is completely extended. As an alternative such springs could be installed in a cylinder and act in compression but this not the preferred mode.

The trellis formed by a row of X-shaped crosses will resist a moment in its plane but is week for moments exerted in planes making an angle with the plane of the trellis. The minimum resistance is in a plane perpendicular to the plane of the trellis. If this trellis is linked by articulations on its side to another congruent trellis and if this second trellis is in a plane making an angle with the first one, we create a structure that gains resistance to moments in planes other than the planes of the two trellis. This resistance is maximum in the plane bisecting the planes of the two trellis. The more acute the angle made by the two trellis, the greater the resistance to a moment in the bisecting plane. In general terms: congruent structures made of trellis linked by articulations on their sides placed in sides of a prism, or in two adjacent planes, or in a succession of planes making a zig-zag pattern will form a structure that resists moments in all directions.

FIG. 6 is a schematic representation of an extensible structure 9 that offers long extensions relative to its collapsed length and is resistant to bending and twisting in all directions, capable of lifting and moving, of exerting force in the direction of its longitudinal axis, of carrying and moving loads at cantilever in any direction and of sustaining lateral loads in any direction.

This extensible structure 9 consists of two congruent articulated rows of X-shaped crosses 19 and 20, similar to the rows of FIG. 1, placed in parallel planes and facing one another orthogonally. A view facing the articulated rows is on the left portion of FIG. 6. To the right of this view there is a side view.

Each X-shaped cross 2 has two arms articulated in its center 3. The arms 10 of the X-shaped crosses are parallel to their arms 11 and their arms 12 are parallel to their arms 13. If one moves from an arm 10 to an arm 13, one will meet successively arms 10, 12, 11 and 13.

Each pair of parallel facing arms 10 and 11 are linked by a web 10-11. Each pair of parallel facing arms 12 and 13 are linked by a web 12-13. These webs are schematically represented on views of cross-sections A-A and B-B. An example of web 10-11 is also schematically represented on the side view at one pair of facing parallel arms 10 and 11. An example of web 12-13 is also schematically represented on the side view at one pair of facing parallel arms 12 and 13.

These webs 10-11 and 12-13 have the particular characteristic of having a void in their central portion. Each void has a depth extending past the center. On FIG. 6, the void of web 10-11 is on the right of the web but the void of web 12-13 is on the left. Thanks to these opposite voids, the webs 10-11 and 12-13 do not interfere with one another when the structure 9 is extended and retracted.

As a less structurally efficient alternative to the above webs, a web arrangement, schematically represented on the far right of FIG. 6, consists of two X-shaped crosses 38 per length of arm of the rows of crosses facing one another plus rods 37 perpendicular to the planes of the rows of crosses facing one another at, or near, their articulations.

The base of the extensible structure is schematically represented at the lower end of FIG. 6. It includes a hinge 14, allowing the rotation of the end pair of arms 10 and 11, and an enveloping rail guide 15 guiding and holding the extremities of the end pair of arms 12 and 13. The actuation of the movement in this enveloping rail guide 15 causes the extension and the retraction of the extensible structure 9. With this arrangement, as the structure extends it shifts sideways. In applications where the structure should not shift sideways, the enveloping rail guide 15a extends over the extremity of arm 11 as well as that of the extremity of arm 13. These two extremities move toward one another by equal increments by actuating them with a screw-drive having a thread on one of its half which is the mirror image of the thread on the other half.

Springs 101 on FIG. 6 linking the above extremities and the opposite articulations joining arms 10 and 13 of FIG. 6 and the articulations joining arms 11 and 12 of FIG. 6 help the actuators.

The other extremity of the extensible structure 9 is schematically represented in two versions at the top of the left side of FIG. 6. One version 9-17 has only half of two facing X-shaped crosses at its end, ending with a rod that includes the articulations 3. The other version 9-18 has a similar arrangement of that used at the base of extensible structure 9, comprising a hinge 14 and a slide or rail 15. It also includes a housing 16 affixed to the enveloping rail guide 15. This housing 16 contains electrical actuators to extend the distance between two wheels 21. These wheels 21 are used when the extensible structure 9 is used as a stabilizer of a crane or of other lifting equipment.

Differing from the structure 1 of FIG. 1, instead of having the cross-section decreasing in all its dimensions as the structure is extended, with the present arrangement of FIG. 6, the dimension parallel to the rows of X-shaped crosses decreases as the structure is extended but the dimension perpendicular to the said rows remains constant. This is the reason why the arrangement of FIG. 6 is the choice for stabilizers which are extended under objects having low ground clearance as, in the applications cited in the texts covering this invention, the moment applied to this structure is in a plane perpendicular to the rows of X-shaped crosses.

FIG. 7 includes two schematic representations of affixing side-by-side an extensible structure 1 of FIG. 1 and an extensible structure 9 of FIG. 6. They extend or retract in unison.

The schematic representation on the left shows, from left to right, an extensible structure 1 affixed to an extensible structure 9.

Adjacent affixed extensible structures share a common row of X-shaped crosses.

The schematic representation on the right shows an extended long crane boom of the type 1 reinforced by two extensible structures of the type 9-17 affixed on either side. From bottom to top are: an elevation in the extended state, a plan view of same, an elevation in the retracted state and a plane view of the retracted state.

The long crane boom has enveloping rail guides 6 of FIG. 1 at its base and at its top end. The enveloping rail guides 6 at the bottom are activated as described in the text covering FIG. 5.

Additional enveloping rail guides 91 on FIG. 24 guiding and holding arms at the end of the structures of type 9-17 of FIG. 6 which are not paired with arms of structure 1 of FIG. 7 are represented schematically on FIG. 24. They are parallel to the enveloping rail guides 6 of the extensible structure 1 of FIG. 7.

FIG. 8 is an illustration of positions of wheels of a mobile crane using two stabilizers which are extensible structures 9 version 17 (see FIG. 6). There are two wheels 22 under the frame 23 of the vehicle and a wheel 21 under each far end of the extensible stabilizers which are extensible structures 9 version 17.

The two wheels 22 can be swivel wheels or electric wheels steered over a full 360 degrees by an angular actuator placed on top of the wheel (see 59 FIG. 12). Furthermore each wheel 22 can be integrated into a suspension which is a combination 24 FIG. 11 of linear actuator-spring-shock absorber that can be locked (see also item 24 on FIG. 12).

Each stabilizer 9 version 17 is articulated at its base with a horizontal pivot 25, where it is linked to the frame, in order to be able to erect the crane on uneven ground. This articulation is activated by a combination 24 FIG. 11 of linear actuator-spring-shock absorber that can be locked.

The two wheels 21, under the extremity of each of the two stabilizers are swivel wheels. In order to reduce the height of the profile of the stabilizers to be able to extend them under objects having small ground clearance whilst maintaining a good wheel diameter to negotiate unevenness in the surface of the road, these wheels can be inclined sideways as is done in a new design of roller skates by LandRoller of California (see FIG. 20).

FIG. 9 is an illustration of positions of wheels of a mobile crane using only one stabilizer which is an extensible structure 9 version 18 (see FIG. 6). There are four wheels 22 under the frame of the vehicle and two wheels 21 under the far end of the extensible stabilizer 9-18.

To provide suspension when travelling, levelling and stead-fasting when using the crane, there are two approaches:
1. each wheel 22 can be integrated as schematically represented on FIG. 12 with a steering powered by an angular actuator 59 and a suspension which is a combination 24 FIG. 11 of linear actuator-spring-shock absorber that can be locked;
2. a suspension linked to each of the two the sub-frames 27; linking the main frame 26 to the mechanisms providing suspension, variation of ground clearance, pitching, rolling and being steadfast at rest; this arrangement is described in the schematic representation of FIG. 13.

The extensible stabilizer 9-18 is articulated at its base with a horizontal pivot 25 where it is linked to the main frame 26 in order to be able to erect the crane on uneven ground. This articulation is activated by a combination 24 FIG. 11 of linear actuator-spring-shock absorber that can be locked.

FIG. 10 is an illustration of four modes of steering. From top to bottom: standard, rotary where the rear wheels follow approximately the tracks of the front wheels, lateral for easy parking and turntable to provide the effect of a crane turn table.

FIG. 11 is a schematic representation of the combination 24 of electric linear actuator 30, coil spring 31 and shock absorber 32, the last equipped with a locking device.

FIG. 12 is an illustration of an integration of electric wheel 62 with angular actuator 59 for steering, and a combination 24 (FIG. 11) of spring, shock absorber with locking device and linear actuator. This combination is affixed to the frame of the vehicle with two brackets 60 that include two bearings that hold the steering shaft 61. The arm 63 is rigidly fastened to the elbow 64 which forms the lower end of the steering shaft 61.

FIG. 13 is a schematic representation in three projections of the mechanisms held by the sub-frames 27 pertaining to the second approach of FIG. 9. On the top-left of the FIG. 13 there is an elevation side-projection where the combination 24a (see 24 on FIG. 11) actuates two congruent parallelograms 34 placed on either side of the combination 24a in order to provide longitudinal suspension, variable ground clearance and pitch. The combination 24b (see 24 on FIG. 11) provides lateral suspension and rolling. The protrusion 29 at the top of sub-frame 27 is a bracket to suspend the wheelchair equipped with a crane to the rear of an automobile or to a trailer. The frontal elevation at the top-right of FIG. 13 shows the two parallelograms 34 on either side of the combination 24a. The frontal elevation at the bottom of FIG. 13 shows the combination 24b and the oscillation pivot 35 of the wheel axle.

FIG. 14 is a schematic representation of a hanger 42 to be installed at the far end of a boom of a crane and joined to the boom by a connection with universal joint 43 and two clutches 44 to tilt and hold the hanger in two orthogonal directions.

The four arms of the hanger 42 hang down from the horizontal by an angle of 31 degrees in order to be able to slope of hanger 42 by 40 degrees in two orthogonal directions (at a horizontal angle of 45 degrees in relation to the arms).

This frame 42 can also be rotated around a vertical axis. The two jaw clutches 44 are used to lock the slopes, one for each of the two directions.

FIG. 15 is a schematic representation of a tube 45 made of a film of composite material, inflatable at high variable pressure, combined with a leaf spring 46 to be used as extensible boom or extensible stabilizer for a crane or wheelchair equipped with a crane or other types of material handling equipment. On the left side of FIG. 15 it is schematically represented as partially uncoiled and, on the right hand side, fully uncoiled.

The leaf spring 46 is a thin leaf spring that recoils. The extent of extension is controlled by a cable and a winch 47. The cable runs in a sheath 48 which is part of the tube in the opposite side to the leaf spring 46.

In some three years moderately priced reinforced films of very high strength containing crystallized cellulose particles (a by-product of a paper mill) will lead to the economical manufacture of light-weight collapsible hoses that will be inflatable with high internal pressure, rendering them sufficiently rigid to be used to build frames. Presently we resort satisfactorily to Kevlar-carbon fibre composites but at a price.

Such rigid structural members, in combination with members made of flexible membranes of lower strength, will lead to all sorts of fully collapsible items.

FIG. 16 is a schematic elevation side view of the wheelchair equipped with a crane.

The two items 62 are two wheels situated under the main frame 23. In the first version of the wheelchair they are just swivel wheels and in the second version they are electric wheels integrated with items 24 and 59 to 64 of FIG. 12.

The main frame 23 of the vehicle is narrow in order to house the retracted stabilizers under the seat which forms a cantilever over the space occupied by the retracted stabilizers.

The main frame 23 is made-up of two sections: a rear section 75 and a front section 74. The wheel base of the two wheels 62 is variable thanks to the sliding beam 65 which slides inside the rear portion 75 of the main frame 23. The actuation of extending and retracting of beam 65 is motorized. The extensible front portion 74 of the main frame 23 carries the front wheel. This extension magnifies the stability of the crane and allows the full reclining of the passenger. The available space in the rear section 75 of the main frame 23 is used as compartment housing electrical components such as batteries and controls.

The seat frame is made-up of three articulated pieces: the backrest 66, the center section 67 supporting the buttock and the thighs and, the last section, the support 68 of the calves and feet.

The backrest 66 has its inclination guided by a vertical enveloping rail guides 69 and by a horizontal enveloping rail guide 70. The movement in this enveloping rail guidel 70 is motorized.

The foot end of section 68 is attached to a horizontal pivot 71 that is part of the extensible front portion 74 of the main frame 23. The motorized extension of the front portion 74 of the frame 23 and the motorized movement of the backrest 66 in enveloping rail guide 70 acting concurrently allow to control the profile of the three pieces 66, 67 and 68 of the seat frame.

The vertical mast is composed of two sections. The lower section 73 is a compartment mounted on the rear section 75 of the main frame 23. It contains electrical components such as batteries and controls. The upper section is an extensible structure 1 of FIG. 1.

The mast is surmounted by an extensible boom 9-17-b which is a horizontal extensible structure 9 of FIG. 6. The boom 9-17-b and the extensible structures 1 of the vertical mast are linked by a vertical pivot which allows to extend the extensible boom 9-17-b in any direction in a horizontal plane. This rotation is motorized.

FIG. 17 is a schematic plan view of the wheelchair equipped with a crane. It has two stabilizers 9-17-a which are extensible structures of type 9 version 17 of FIG. 6. These stabilizers have a low profile in order to be able to extend them under objects having a small ground clearance. There is a swivel wheel 21 under each far end of the extensible stabilizers 9-17-a.

In order to be able to use the crane on uneven ground, in the second version of the wheelchair, each stabilizer 9-17-a is articulated at its base with a horizontal pivot 25, where it is linked to the main frame 23. This articulation is activated by a combination 24 FIG. 11 of linear actuator-spring-shock absorber that can be locked. Thus these stabilizers are also part of the vehicle as they provide two of its wheels and also half of its suspension.

In addition, in both the first and second versions, a vertical pivot can be installed at the base of each stabilizer to be able to spread the stabilizers.

The position of the boom 9-17-b is designed to move the user between the seat of the wheel chair and any other object. It also makes the fully retracted boom fit within the floor space occupied by the vehicle when travelling in restricted space.

FIG. 18 is a schematic elevation rear view of the wheelchair equipped with a crane. It shows the backrest section 66 of the seat frame. It is guided by the vertical enveloping rail guide 69 and the horizontal enveloping rail guide 70 which are both situated at the far left of the unit. The seat frame is held at cantilever. Its stability is ensured by the angle formed between the sections 66 and 67 and by the bloc 76 on which the bottom of section 66 slides. The hanger 42 of FIG. 14 and its features 42 and 44 to vary its angles of slope are indicated.

FIG. 19 shows, on its right, a schematic side view and, on its left side, a schematic plan view of a seat cover that can be used as an inflatable mattress comprising three sections that can be individually tilted. Each section is bordered with tubes 55 inflated at high pressure to provide rigid frames. The tilting is activated and held by artificial muscles 56. A removable chamber pot 57 is attached under the mattress.

Linking the tubes 55 of the four sides of each frame and filling the space within each frame, there are three superposed membranes 58. These membranes 58 are spot welded one to the other or held together by other means in spots making a regular pattern. The spots of the pattern that link the top membrane to the middle membrane alternate with the spots of the pattern linking the middle membrane to the bottom membrane.

A fluid, at a pressure lower than that in the tubes, introduced in one of the two chambers or in the two chambers created by the three membranes 58 will result in a bumpy cushioned surface. Introducing and removing fluid alternately between the two chambers will create a sort of massage and movement of air to prevent bed sores.

When laying on a bed, the pressure inside the tubes can be decreased or even annulled and so can the pressure between the membranes. However the alternating inflation-deflation between the membranes can be maintained at will.

The seat cover has at least two eyes pierced on either side to receive hooks that are part of detachable straps hanging from a module as represented on FIG. 14.

FIG. 20 is a schematic representation of an incline swivel wheel.

FIG. 21 is a schematic representation of an extensible trellis type structure mounted horizontally at the counterweight end of the boom of a tower crane. The counterweight is placed at the far end of said structure.

Going from the bottom to the top of the figure FIG. 21 are: an elevation showing the extensible trellis type structure 79 fully extended, a plan view of same, an elevation with said structure retracted and a plan view with same.

76 is the horizontal boom and 77, the vertical mast.

Thanks to the fact that the position of counterweight 78 is variable, the moment that balances the moment of the lifting portion of the boom 76 plus that of the live load at 80 can automatically be maintained equal to the latter. With this arrangement the counterweight 78 is lighter, the maximum live load at 80 is increased and there is no moment applied to the mast 77 and to the turn table 81 at the top of the mast.

FIG. 22 is a schematic representation of a mobile crane with extensible trellis type structures corresponding to that of FIG. 6 used for the boom 93 and the rear extensible structure 94 carrying a counterweight 95 at its far end. The counterweight 95 consists entirely or partially of batteries to store electricity. The four wheels 92 under the vehicle are each part of an assembly of FIG. 12.

From the bottom to the top of FIG. 22 successively are schematic representations of an elevation of the crane with boom 93 and counterweight 95 extended, a plan view corresponding to the previous elevation, an elevation with the boom 93 and the counterweight 95 retracted and finely the same in plan view.

The boom 93 swings vertically around the horizontal axis 96. This swing is powered by a tackle 97 and a winch 98. The tackle 97 has one end attached to the frame and the other end, to a lever attached to the base of boom 93. This tackle is reined-in by the winch 98. A preferred solution as an alternative to the use of a tackle is to incorporate a planetary gear reducer to a worm gear drive in the winch.

This mobile crane, thanks to its relatively light weight and small size when its extensible structures are retracted and when the boom 93 is lowered, can be transported on its two rear wheels 92 with its front on the back of a pick-up truck equipped similarly as when equipped to haul a swan-neck camping trailer.

Furthermore, the same arrangement minus items 92, 94 and 95, with just the boom 93, articulation 96, tackle 97 and winch 98, could be mounted on a truck with the boom facing backward. The truck will be equipped on either side of its rear end with a swivel wheel that can each be individually extended side-ways and moved up and down with an arrangement 24 of FIG. 11 to operate the crane on a slope and also to lift the wheels off the ground when the truck is travelling. The horizontal orientation of the crane will be accomplished by steering the truck. The truck will act as counterweight and an additional counterweight includind batteries storing electricity for the operation of the crane are installed at the front of the truck.

FIG. 23 is a schematic representation of a mobile crane with extensible trellis type structures used for the boom 81 and for two stabilizers 82. Each stabilizer is carrying a counterweight 90 at its end. These stabilizers 82 are power-oriented vertically by the two linear actuators 87 and horizontally by the two linear actuators 89. The angle of the boom 81 with the horizontal is set by the linear actuator 86.

The wheels 83 are steered with angular actuators and their spindle includes an assembly shematically represented on FIG. 11.

The wheels 84 are steered with angular actuators and have a spring suspension with shock absorber.

For the purpose of illustration, on FIG. 23, the main frame 85 and the linear actuators are overblown in relationship to the boom 81, the stabilizers 82 and the wheels 83 and 84.

FIG. 24 is a schematic representation of the slides or rails guiding and holding the arms at the ends of trellis type extensible structures when a structure of FIG. 1 is affixed to a structure of FIG. 6 as represented on the left hand side of FIG. 7.

The enveloping rail guides 6 are the enveloping rail guides 6 of FIGS. 1 and 5 but here the two enveloping rail guides 6 on the right guide hold pairs of arms, one from the said extensible structure of FIG. 1 and one from the said extensible structure of FIG. 6. The enveloping rail guides 91 guide and hold the two remaining arms of said extensible structure of FIG. 6.

The enveloping rail guides 91 are congruent to the enveloping rail guides 6 on the right side and the enveloping rail guides 91 are each respectively parallel to an enveloping rail guide 6.

The six enveloping rail guides are part of the same assembly.

FIG. 25 is a schematic representation in three orthogonal views showing in each view only part of the equipment in order not to clutter the presentation. It shows a vertical extensible mast 102 of the type represented on FIG. 1 supporting a horizontal extensible boom 105 of the type represented on FIG. 6. The latter can be swung in any direction using an angular actuator 108. A vertical pivot 107 links the horizontal boom 105 to the vertical mast 102. In this example, springs can power the lifting by the vertical mast on their own. Two tackles 113 control the extension and perform the retraction. Their cables are hauled and release by a common winch 115 which is attached to the support 106 of the horizontal extensible boom 105. They are mounted in such a way that they rotate with the boom 105 and increase the rigidity of the mast 102 in the direction of the boom 105. The rotation of these two tackles 113 is accomplished by attaching them, at their top, to the base 106 of the horizontal extensible boom 105 and, at their bottom, to rollers 112 free to move in an enveloping rail 111 making a circle or a portion of a circle attached to the assembly 103 at the bottom of the extensible mast 102. The winch 115 is attached to the support 106.

FIG. 26 is a variation of FIG. 25 where there is only one tackle 113 instead of two. Instead of attaching the top of the tackle 113 to the rear of the base 106 of the horizontal extensible boom 105, it is now attached to the far extremity of an additional horizontal extensible boom 116 mounted at the rear of the horizontal extensible boom 105 and extending in the opposite direction. The winch 115 is now attached to the far extremity of the additional horizontal extensible boom 116. The force applied to the tackle 113 combined with the degree of extension of the additional horizontal extensible boom 116 are programmed to insure that the moment they create in the vertical plane parallel to the horizontal extensible boom 105 equals the moment which solicits the horizontal extensible boom 105. A preferred solution as an alternative to the use of a tackle is to incorporate a planetary gear reducer to a worm gear drive in the winch.

For a fast response to the lifting or release of a load to balance the moment applied to the boom 105, the winch 115 has a faster action than the actuation of the vertical mast 102.

FIG. 27 is a schematic representation in two orthogonal projections of one of two configurations of a coupling system to join modules such that all interchangeable modules carry identical fixtures forming a congruent pattern that are either all female or all male elements joined respectively by all male or all female couplings. The configuration in the schematic representation is that of male fixtures 117 with female couplings 118. To assemble, the two flat ends of the two male features are placed against one another, forming one cylinder. The two female couplings consisting of two rings are then slid in at the two ends of the cylinder to hold the two halves of the cylinder together. The two rings are linked by a clip or other means to prevent them from slipping away.

FIG. 28 is a schematic representation of a restraining mechanisms 122 linking the two ends of an extensible structure 123, releasing at low speed but locking at fast speed, such as used for automobile seatbelts, to prevent uncontrolled expansion of said extensible structure 123, equipped with single action spring actuator(s) as represented on FIGS. 2, 5 and 25, in case of failure of a single action actuator comprising cable with winch.

FIG. 29 is a schematic representation of a thin springy solid sheet forming a ribbon coil 119 having one end fastened by a pivot 120, perpendicular to the surface of said ribbon coil, to a distal arm extremity at one end of an extensible structure as represented on FIG. 1 and FIG. 6 and having the other end fastened to a distal arm extremity at the opposite end of said structure; the ribbon coil 119 wrapping around the said structure and extending in the form of a spiral that stretches longitudinally and simultaneously shrinks its cross section in step with the longitudinal extension and simultaneous shrinkage of cross section of said structure. The edges of the ribbon have opposite narrow channels 121 on either side. The representation on the left side is a longitudinal cross section at center of the ribbon coil in the retracted stage and the representation on the right side is the cross section in a fully extended stage. The purpose of the narrow channels is to ensure that no void can appear in the wall formed by the ribbon coil around the said extensible structure. The function of the ribbon coil is to prevent the introduction of foreign objects in the trellis of said structures.

I claim:

1. A wheelchair equipped with a crane capable to handle the wheelchair user.

2. A wheelchair as recited in claim 1 comprising extensible modules, systems and interface elements.

3. A wheelchair as recited in claim 1 including a vertical extensible mast surmounted by an extensible boom linked to said mast by a vertical pivot.

4. An extensible module comprising articulated trellis, equipped with fixtures to affix it to other modules, systems and interface elements having its own extension and retraction actuators; said trellis including articulated arms forming an extensible structure having congruent X-shaped crosses and wherein:
the X-shaped crosses are articulated at their center and connected end-to-end with articulations;
the X-shaped crosses form rows of articulated X-shaped crosses;
each individual row is situated longitudinally in one of a minimum of two consecutive virtual flat rectangular panels successively connected along their longitudinal sides and whose intersections, which correspond to their sides, intersect a plane perpendicular to their sides on the same circumference;
the end-to-end articulations of the X-shaped crosses of the rows in adjacent virtual flat rectangular panels are connected to one another by corner pieces carrying said articulations;
the corner pieces at both ends of said arrangement of virtual flat rectangular panels carry a post and the end of each said post is equipped with an object suitable to move in an enveloping guide rail which is situated in a tray perpendicular to the said intersections; said enveloping guide rail being aligned on a radius from a point common to the radii of enveloping rail guides of all the said corner pieces; said enveloping guide rail enveloping said object to prevent it from moving in a direction parallel to the said intersections;
arm extremities of X-shaped crosses at both ends of the extensible structure which do not bear an articulation are also equipped with an object suitable to move in an enveloping guide rail similar to the said enveloping guide rail, situated in the same said tray and oriented similarly.

5. An extensible module comprising articulated trellis, equipped with features to affix it other modules, systems and interface elements, having its own extension and retraction actuators, said trellis including articulated arms forming an extendible structure having congruent shaped crosses and wherein:
the X-shaped crosses are articulated at their center and connected end-to-end with articulations;
the X-shaped crosses form rows of articulated X-shaped crosses;
two said congruent articulated rows of X-shaped crosses are placed in parallel planes and facing one another orthogonally;
each pair of facing congruent X-shaped crosses is linked by two crossing webs;
these webs do not interfere with one another when the said extensible structure is extended or retracted;
the said extensible structure lends itself to varying step by step the distance between the parallel planes of an X-shaped cross and the opposite X-shaped cross, decreasing from one end to the other end of the said extensible structure;
arm extremities of X-shaped crosses at both ends of the extensible structure are equipped with an object suitable to move in an enveloping guide rail which is situated on a structure forming a tray perpendicular to the rows of X-shaped crosses and parallel to the rows of X-shaped crosses; said enveloping guide rail is enveloping said object to prevent it from moving in a direction perpendicular to the said tray.

6. An extensible module joining two elements whose spacing has to be managed, comprising a linear actuator, a coil spring and a shock absorber, said shock absorber being lockable to render the spring inoperative; said module being fitted at each opposite end with half a wrist pin junction adapted to mate with an other half of the wrist pin junction being part of each of the said elements.

7. A plumbline controlling automatically a linear actuator as recited in claim 6

8. A wheelchair equipped with an extensible module as recited in claim 4.

9. A crane equipped with an extensible module as recited in claim 4.

10. A wheelchair equipped with an extensible module as recited in claim 5.

11. A crane equipped with an extensible module as recited in claim 5.

12. A wheelchair equipped with an extensible module as recited in claim 6.

13. A vehicle equipped with an extensible module as recited in claim 6.

14. An extensible module comprising articulated trellis, having its own extension and retraction actuators, equipped with features to affix it to a structure, being a juxtaposition and linkage of extensible structures as provided in claims 4 and 5, sharing a common row of congruent X-shaped crosses and integrating their end structures forming trays that hold enveloping guide rails, with enveloping guide rails pertaining to corner pieces each aligned on a radius from a point common to the radii of enveloping guide rails of all the said corner pieces and the enveloping guide rails pertaining to the extremities, that are not paired with guide rails related to corner pieces, respectively running parallel to the paired one situated on the same side of the webs.

15. An extensible module as recited in claim 5 carrying a counterweight at a distal extremity thereof, mounted at a rear end of a another extensible structure, pointing in a direction opposite to a direction of said other extensible structure, having its degree of extention automatically controlled by sensors to counter-balance automatically a moment in the vertical plane soliciting said other extensible structure.

16. A counterweight as recited in claim 15 containing batteries storing electricity.

17. An extensible module as recited in claim 4 or 5, wherein actuators comprise a combination of double acting and single acting actuators, said actuators joining elements which move away from one another when said extensible module is retracted; the double acting actuators being selected from the group comprising linear actuators, side-track actuators, screw drives and screw drives having a thread of a half of a screw that is a mirror image of a thread of a second half thereof and the single acting actuators being selected from the group comprising coil springs, that are taut when said extensible module is in a retracted state and relax gradually when said extensible module is being extended, and cables hauled in or released by at least one winch.

18. An extensible module as recited in claim 17, wherein springs act alone to extend extensible structures and where cables, hauled in and released by winches, act alone to retract the extensible structures.

19. An extensible module as recited in claim 4, being actuated by an angular actuator affixed under the center of one of the two trays, rotating a wheel hub with radial spokes, said spokes being linked to connecting rods that, in turn, are linked to extremities of the rows of X-shaped crosses and combining the action of said angular actuator with springs that link elements which move away from one another when retraction takes place, said springs assisting the angular actuator, said angular actuator not interfering with the fixtures of said module to affix it to other modules.

20. A wheelchair as recited in claim 2, wherein at least one of the extensible modules consists in an extensible stabilizer with its extremity supported by a wheel, said stabilizer having its extremity capable to be attached to a fixed object.

21. A wheelchair comprising an extensible module as recited in claim 20, wherein the extensible module is further equipped with a motorized articulation to vary its angle with the horizontal, and having the actuation of the angle with the horizontal controlled by a second extensible module joining two elements whose spacing has to be managed, comprising a linear actuator, a coil spring and a shock absorber, said shock absorber being lockable to render the spring inoperative; said second module being fitted at each opposite end with half a wrist pin junction, adapted to mate with another half of the wrist pin junction being part of each of the spaced elements.

22. A wheelchair as recited in claim 21, wherein the extensible structure is further equipped with a motorized articulation to vary its horizontal direction.

23. A wheelchair as recited in claim 3, further equipped with an extensible module consisting of a system to counter-balance a moment soliciting the boom, comprising a portion of a circular rail, corresponding to an operating swing of the boom, mounted around a base of the extensible vertical mast, said portion of circular rail holding a roller which is linked to an end of an extensible structure, mounted at a rear end of the boom and pointing to a direction opposite to a direction of said boom, by a cable and winch assembly with high reduction; program combination of extension of the additional extensible structure and pull on the cable to automatically counter-balance the moment soliciting the boom; said cable being hauled and released by the winch, and the cable and winch being capable of acting to retract the vertical extensible mast.

24. A crane equipped with a vertical extensible mast surmounted by an extensible boom linked to said mast by a vertical pivot, further equipped with a module as recited in claim 23.

25. A wheelchair as recited in claim 2 comprising a vehicular steering system having individually power-steered front and rear vehicular wheels that can be oriented at any angle within a full 360 degrees range, the system implementing four modes of steering:
standard steering by front wheel(s), the rear wheel(s) remaining in one fixed direction;
the front and rear wheel(s) steer in opposite directions to allow the rear wheel(s) to approximately follow a track of the front wheel(s);
all wheels are steered in the same direction for easy parking;
the wheels are steered to have the virtual extension of their respective axis intersecting a common vertical straight line to act as a turntable.

26. A vehicular steering system comprising individually power-steered front and rear vehicular wheels that can be oriented at any angle within the full 360 degrees range, the system implementing four modes of steering:
standard steering by front wheel(s), the rear wheel(s) remaining in one fixed direction;
the front and rear wheel(s) steer in opposite directions to allow the rear wheel(s) to approximately follow a track of the front wheel(s);
all wheels are steered in the same direction for easy parking;
the wheels are steered to have the virtual extension of their respective axis intersecting a common vertical straight line to act as a turntable,
wherein a spindle of an electric vehicular wheel is integrating a module as recited in claim 6, providing both suspension and variable ground clearance; said spindle and said module in turn form a module.

27. A wheelchair as recited in claim 20, having a module comprising a narrow main frame having an extensible front portion, capable of accommodating two extensible stabilizers, placed side-by-side on a same side of the main frame, one of said extensible stabilizers being attached to the main frame and the other to the extensible front portion, the sum of a width of the frame plus a retracted length of the said extensible stabilizers making the said extensible stabilizers retractable within the perimeter of this module when traveling; and having a wheel supporting the extensible front portion of the main frame and one wheel supporting the rear of the main frame.

28. A wheelchair as recited in claim 20, wherein one of the modules consists of a short main frame having an extensible front portion, capable to accommodate two extensible stabilizers, having a distal extremity supported by a wheel, attached side-by-side to the extensible front portion, the sum of a retracted length of the main frame plus a retracted length of the extensible stabilizers making the said extensible stabilizers retractable within the perimeter of this module when traveling; and having two wheels supporting the rear of the main frame.

29. A wheelchair as recited in claim 20, wherein one of the modules is comprised of a main frame with an extensible front portion, capable of accommodating one extensible stabilizer attached to a side of the main frame in a recess of the main frame, the depth of the recess being at least equal to a retracted length of the said extensible stabilizer; two wheels supporting the extensible front portion of the main frame; two wheels supporting the rear of the main frame.

30. A wheelchair as recited in claim 3, comprising a seat module mountable to a main frame having an extensible front portion, said seat module comprising a seat frame made-up of three articulated pieces: a backrest, a center section for supporting the user's buttock and thighs and a last section, having a foot supporting end, with the backrest having its incline adjusted by the combination of a vertical enveloping guide rail guiding a top portion thereof and of a horizontal enveloping guide rail guiding a bottom portion thereof, said enveloping guide rails being located at one edge of the said seat frame which approximately corresponds to an outside edge of said main frame, movement in one of said two enveloping guide rails being motorized and the foot supporting end being attached to a horizontal pivot that is part of the extensible front portion of said main frame; whereby the combination of the motorized extension of the front portion of the said main frame and of the motorized movement of the backrest enables to control the profile of the three pieces of the seat frame, from an up-straight configuration to full reclining to form a stretcher; the seat frame being held at cantilever from the enveloping guide rails and projecting sideways; the stability of the seat frame being ensured by the backrest and the center section of the seat frame forming an angle therebetween and by a sliding surface on top of the main frame on which the bottom portion of the backrest slides; said center section having an aperture to lodge a chamber pot.

31. A wheelchair as recited in claim 2, comprising a hanger at the end of a boom, capable to change an inclination of a user hanging in a harness attached to the hanger; said hanger being joined to a boom by a vertical pivot and a connection with universal joint and two clutches to tilt and hold the hanger in two orthogonal directions.

32. A wheelchair as recited in claim 1, further comprising brackets affixed to extensible portions of the wheelchair to connect onto supports affixed to the rear of an automobile to perform loading and unloading with the help of actuators which are part of said wheelchair equipped with a crane.

33. A wheelchair as recited in claim 2 comprising a coupling system for integrating and interfacing modules, systems and interface elements, comprising compatible fastening fixtures for integrating and interfacing; the interfacing elements selected from the group comprising:
two parallel plates linked by a pivot perpendicular to said plates,
a bracket holding the spindle of a wheel,
a bracket holding the spindle of a wheel and capable of holding an angular actuator,
a tray comprising said compatible permanent fastening fixtures and capable to be affixed to a frame;
said fastening fixtures capable to couple with like fixtures mounted on cranes and vehicles.

34. An extensible structure as recited in claim 4 and in claim 5 comprising a restraining mechanism linking the two ends of said extensible structure, whose extension is actuated with the help of springs, releasing at low speed but locking at fast speed, such as used for automobile seatbelts, to prevent uncontrolled expansion of said extensible structure.

35. An extensible structure as recited in claim 4 comprising a thin springy solid sheet forming a ribbon coil having one end fastened to a distal extremity of an arm of X-shaped cross at one end of an extensible structure and having the other end fastened to a distal extremity of an arm of X-shaped cross at the opposite end of said structure; the ribbon coil wrapping around the said structure and extending in the form of a spiral that stretches longitudinally and simultaneously shrinks its cross section in step with the longitudinal extension and simultaneous shrinkage of cross section of said structure; and an extensible structure as recited in claim 5 having a similar arrangement mounted on said extensible structure.

36. A wheelchair as recited in claim 1, comprising a seat cover framed with pressurised tubes made of composite films acting as structural elements, said seat cover also used as mattress and equipped with a removable chamber pot; said seat cover having at least two eye-lets on either side to receive hooks that are part of straps.
